(19) United States
(12) Patent Application Publication
(10) Pub. No.: US 2023/0099281 A1
(43) Pub. Date: Mar. 30, 2023

(54) One Piece Adjustable Shower Arm

(71) Applicant: Christopher Doherty, Trabuco Canyon, CA (US)

(72) Inventor: Christopher Doherty, Trabuco Canyon, CA (US)

(21) Appl. No.: 17/874,654

(22) Filed: Jul. 27, 2022

Related U.S. Application Data
(63) Continuation-in-part of application No. 29/811,631, filed on Oct. 15, 2021.
(60) Provisional application No. 63/250,015, filed on Sep. 29, 2021.

(51) Int. Cl. B05B 15/68; E03C 1/04

(52) U.S. Cl. CPC B05B 15/68; E03C 1/0408

(57) ABSTRACT

The present invention provides a shower arm device comprising a first pipe, a second pipe, a flange, a plurality of articulated elbows attached to the first pipe and the second pipe connecting the first pipe and the second pipe, a plurality of articulated elbows attached to the second pipe connecting to a showerhead and a plurality of knobs attached to the plurality of articulated elbows.

### FIELD OF THE INVENTION

The present invention relates generally to a shower arm. More specifically, the shower arm provides two articulated elbows allowing for vertical adjustments, resulting in lowering or raising the level of the shower head.

### BACKGROUND OF THE INVENTION

Taking shower means having a bath under a spray of warm or hot water. Typically, a showerhead distributes water from overhead a bather, and a shower arm or hose that is connecting the water source and the showerhead adds greater convenience and efficiency in taking shower. The shower arm allows the bather to adjust the water distribution point and spray the water at different parts of the body.

An objective of the present invention is to provide an improved shower arm that adds convenience and efficiency in taking shower. The present invention provides two articulated elbows allowing for vertical adjustments, resulting in lowering or raising the level of the showerhead. The shower arm connects directly to the water source inside the wall. The two elbows can be articulated and locked into place by turning the knobs on the elbows clockwise. Additional features and benefits are further discussed in the sections below.

### BRIEF DESCRIPTION OF THE DRAWINGS

FIG. 1 is a top front perspective view of the present invention.

FIG. 2 is a top plan view of the present invention.

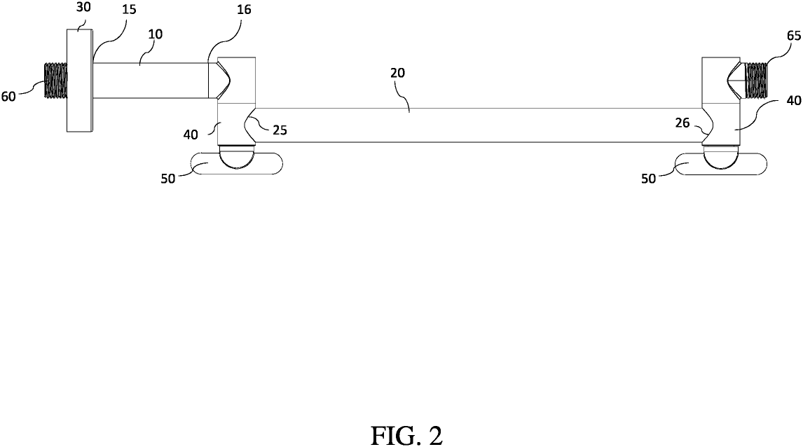

FIG. 3 is a front perspective view of the exemplary assembly of the present invention with a showerhead.

### SUMMARY

In accordance with the present invention, a novel shower arm device is provided. The present invention comprises a first pipe, a second pipe, a flange, a plurality of articulated elbows attached to the first pipe and the second pipe connecting the first pipe and the second pipe, a plurality of articulated elbows attached to the second pipe connecting to a showerhead and a plurality of knobs attached to the plurality of articulated elbows.

In one embodiment, present invention includes pipes that are pivotably coupled with the articulated elbow that allows the bather to adjust the height and angle to meet the specific needs.

In some embodiments, the ends of the present invention can be connected to a threaded male fitting to attach a showerhead to the present invention and to attach the present invention to a wall.

### DETAIL DESCRIPTIONS OF THE INVENTION

All illustrations of the drawings are for the purpose of describing selected versions of the present invention and are not intended to limit the scope of the present invention.

The present invention, also referred to as the “One Piece Adjustable Shower Arm,” provides an improved shower arm that comprises two articulated elbows allowing for vertical adjustments, resulting in lowering or increasing the level of the showerhead.

The shower arm can be mounted directly to the water source inside the wall.

In a preferred embodiment, the present invention provides a shower arm device 100 that comprises a first pipe 10, a second pipe 20, a flange 30, a plurality of articulated elbows 40, and a plurality of knobs 50. The pipes carry water from the water source to the showerhead. The flange covers the hole where the shower arm attaches to the water source pipe in the wall. The articulated elbows 40 and knobs 50 allow the bather to adjust and lock the pipes into the desired position.

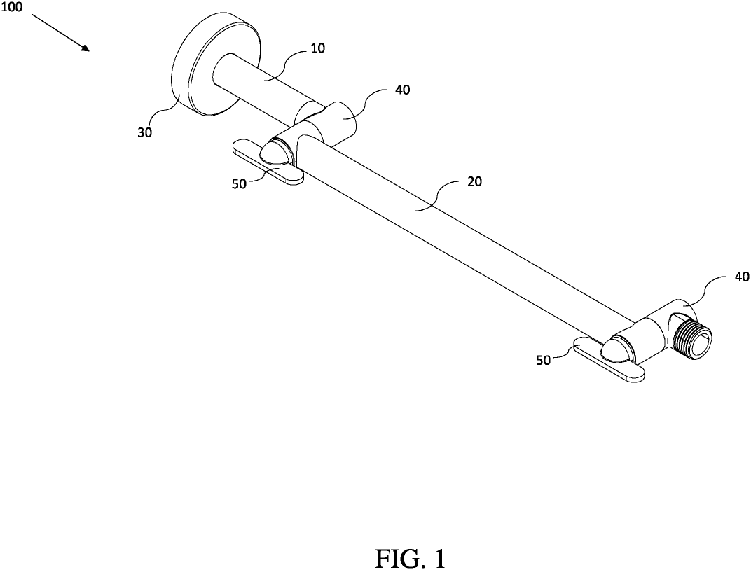

As can be seen in FIGS. 1 - 3, the first pipe 10 and the second pipe 20 provide hollow and cylindrical shape/structures. In the preferred embodiment, the first pipe 10 is shorter compared to the second pipe 20, although any desired length may be used.

As can be seen in FIGS. 1 - 2, the one end (first end 15) of the first pipe 10 comprises the flange 30 and a wall male fitting thread 60 that connects the present invention directly to the water source pipe inside the wall. The flange 30 provides a projecting flat rim structure, although any desired design may be used. As can be seen in FIGS. 1 - 2, the other end (second end 16) of the first pipe 10 is connected to the articulated elbow 40.

The first pipe 10 and the second pipe 20 are pivotably coupled with the articulated elbow 40. The articulated elbow 40 allows the bather to adjust the height and angle to meet the specific needs. The plurality of pipes (the first pipe 10 and the second pipe 20) and the plurality of articulated elbows 40 form continuous water channels configured to fluidly connect the water source with the showerhead. The plurality of articulated elbows 40 comprises a locking mechanism that engages the pipes (the first pipe 10 and the second pipe 20) and the articulated elbows 40 to securely locks the position.

The bather can unlock the locked configuration by turning the knobs on the articulated elbows 40 counterclockwise or lock by turning the knobs 50 on the articulated elbows 40 clockwise.

As can be seen in FIGS. 1 - 2, the second pipe 20 and the shower male fitting thread 65 for the showerhead are pivotably coupled with the articulated elbow 40.

In some embodiments, one end (first shower end 25) of the second pipe 20 can be connected to the articulated elbow 40 and the other end (second shower end 26) of the second pipe 20 can be connected to the shower male fitting thread 65 which can be a threaded pipe configured to connect to a showerhead 70.

The articulated elbow 40 comprises the aforementioned locking mechanism that engages the pipe (the second pipe 20) and the articulated elbow 40 to securely locks the position.

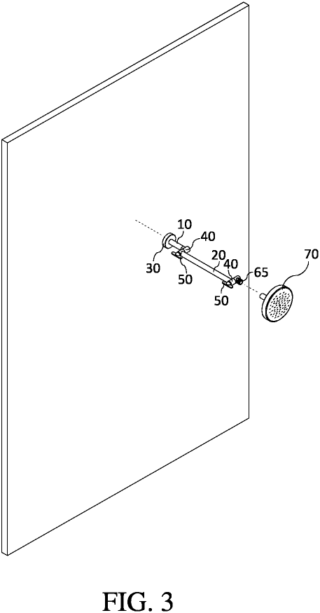

As can be seen in FIG. 3, a round showerhead 70 is attached to the present invention via the shower male fitting 65 for the showerhead 70, although any desired shape of the showerhead may be attached.

In the preferred embodiment, the present invention is constructed from brass or stainless steel for long-lasting durability and corrosion resistance, although any desired materials may be used.

Although the invention has been explained in relation to its preferred embodiment, it is to be understood that many other possible modifications and variations can be made without departing from the spirit and scope of the invention.

What is claimed is:

1. A shower arm device comprising:
a first pipe having a first end and a second end;
a second pipe having a first shower end and a second shower end;
a flange connected to the first end of the first pipe, the flange having a wall male fitting thread,
a plurality of articulated elbows attached to the second end of the first pipe and the first shower end of the second pipe connecting the first pipe and the second pipe;
a plurality of articulated elbows attached to the second shower end of the second pipe; and
a plurality of knobs attached to the plurality of articulated elbows.

2. The shower arm as claimed in claim 1, wherein the first pipe includes a hollow cylindrical shape.

3. The shower arm as claimed in claim 1, wherein the second pipe includes a hollow cylindrical shape.

4. The shower arm as claimed in claim 1, wherein the plurality of articulated elbows are pivotally attached to the second end of the first pipe and pivotally attached to the first shower end of the second pipe.

5. The shower arm as claimed in claim 1, wherein a plurality of articulated elbows are pivotally attached to the second shower end of the second pipe.

6. The shower arm as claimed in claim 1, wherein one end of the plurality of articulated elbows attached to the second shower end of the second pipe is attached to a shower male fitting.

7. The shower arm as claimed in claim 1, wherein the shower male fitting is attached to a showerhead.

8. A shower arm device comprising:
a first pipe having a first end and a second end;
a second pipe having a first shower end and a second shower end;
a flange connected to the first end of the first pipe, the flange having a wall male fitting thread,
a plurality of articulated elbows attached to the second end of the first pipe and the first shower end of the second pipe connecting the first pipe and the second pipe, wherein the second pipe is longer than the first pipe;
a plurality of articulated elbows attached to the second shower end of the second pipe; and
a plurality of knobs attached to the plurality of articulated elbows.

9. The shower arm as claimed in claim 6, wherein the first pipe includes a hollow cylindrical shape.

10. The shower arm as claimed in claim 6, wherein the second pipe includes a hollow cylindrical shape.

11. The shower arm as claimed in claim 6, wherein the plurality of articulated elbows are pivotally attached to the second end of the first pipe and pivotally attached to the first shower end of the second pipe.

12. The shower arm as claimed in claim 6, wherein a plurality of articulated elbows are pivotally attached to the second shower end of the second pipe.

13. The shower arm as claimed in claim 6, wherein one end of the plurality of articulated elbows attached to the second shower end of the second pipe is attached to a shower male fitting.

14. The shower arm as claimed in claim 12, wherein the shower male fitting is attached to a showerhead.

15. A shower arm device comprising:
a first pipe having a first end and a second end;
a second pipe having a first shower end and a second shower end;
a flange connected to the first end of the first pipe, the flange having a wall male fitting thread,
a plurality of articulated elbows attached to the second end of the first pipe and the first shower end of the second pipe connecting the first pipe and the second pipe, wherein the second pipe is longer than the first pipe;
a plurality of articulated elbows attached to the second shower end of the second pipe, wherein one end of the plurality of articulated elbows attached to the second shower end of the second pipe is attached to a shower male fitting; and
a plurality of knobs attached to the plurality of articulated elbows.

16. The shower arm as claimed in claim 13, wherein the first pipe includes a hollow cylindrical shape.

17. The shower arm as claimed in claim 13, wherein the second pipe includes a hollow cylindrical shape.

18. The shower arm as claimed in claim 13, wherein the plurality of articulated elbows are pivotally attached to the second end of the first pipe and pivotally attached to the first shower end of the second pipe.

19. The shower arm as claimed in claim 13, wherein a plurality of articulated elbows are pivotally attached to the second shower end of the second pipe.

20. The shower arm as claimed in claim 13, wherein the shower male fitting is attached to a showerhead.
